(19) United States
(12) Patent Application Publication
(10) Pub. No.: US 2015/0260108 A1
(43) Pub. Date: Sep. 17, 2015

(54) VARIABLE CHARGE MOTION APPARATUS OF ENGINE AND DIAGNOSTIC METHOD THEREOF

(71) Applicants: Hyundai Motor Company, Seoul (KR); Kia Motors Corporation, Seoul (KR)

(72) Inventor: Do Geun Jung, Suwon (KR)

(21) Appl. No.: 14/551,272

(22) Filed: Nov. 24, 2014

(30) Foreign Application Priority Data
Mar. 12, 2014 (KR) 10-2014-0028678

(51) Int. Cl. F02D 9/10; F02D 41/00

(52) U.S. Cl. CPC F02D 9/10; F02D 41/0002; F02D 2009/0201

(57) ABSTRACT

The present invention includes a VCM apparatus, and method of use, to create tumble in an engine combustion chamber while suppressing costs of engine manufacture by appropriately diagnosing failure conditions such as a deformation of a flap and a damage of a link connecting the flap to a VCM actuator without the need for an additional sensor mounted near the flap.

### CROSS-REFERENCE TO RELATED APPLICATIONS

The present application claims priority of Korean Patent Application No. 10-2014-0028678 filed on Mar. 12, 2014, the entire contents of which are incorporated herein by reference.

### BACKGROUND

1. Field of the Invention

The present invention relates to a variable charge motion apparatus and, more particularly, to diagnosing a failure of a variable charge motion (VCM) apparatus controlling an intake flow for an engine.

2. Description of the Related Art

A variable charge motion (VCM) apparatus tumbles suction air in an engine to promote mixing of air and fuel within a combustion chamber, to improve combustion properties of the engine. Tumble is a type of turbulence which may be found in combustion cylinders of engines upon intake of air and fuel, and is generally described by turbulent flow about a circumferential axis.

FIGS. 1 and 2 illustrate parts of an exemplary VCM apparatus according to the present invention mounted to a typical intake manifold 1 according to the related art. In the figures, the intake manifold 1 may include a flap 3 mounted adjacent to a portion of the engine when the intake manifold 1 is mounted and the intake manifold 1 is connected to a VCM actuator 5 via a link 7 to rotate the flap 3; FIG. 3 separately illustrates the flap 3.

To more easily control tumble formed in the combustion chamber, the flap 3 may be preferably mounted near the combustion chamber. As illustrated, the flap 3 may be mounted adjacent to a portion of the engine when the intake manifold 1 is mounted. In particular, since the position adjacent to the engine is near other components and is a substantially narrow space, the VCM actuator 5 is shown mounted at a position spaced apart from the flap 3, but close enough to deliver an operating force from the VCM actuator 5 to the flap 3. In addition, due to the spaced-apart orientation, a link 7 may connect the VCM actuator 5 to the flap 3, as shown and as described above.

FIG. 4 conceptually illustrates that a controller 9 such as an engine control unit (ECU) may be configured to drive the VCM apparatus as described above. In the configuration of the VCM apparatus as described above, a VCM actuator 5 may include a motor 11 configured to generate an operating force to be supplied to the flap 3 and the controller 9 may be configured to determine an operating angle for the motor 11 using a signal from a motor position sensor 13, which may be disposed within the motor and may be configured to indirectly recognize a rotating angle of the flap 3 based on the operating position of the motor.

In response to determining a failure, (e.g., caused by damage to the link 7, deformation of the flap 3, or the like), the operating angle of the motor 11 may not properly adjust the rotating angle of the flap 3. Accordingly, a sensor configured to sense a position of the flap 3 may be additionally required. Such a sensor may be mounted in close proximity to the flap 3, but use of such an additional sensor may increase costs associated with manufacturing the engine. In addition, mounting the sensor in a location proximate to the flap may be difficult due to limitations in the layout of the engine.

The matters described as the related art have been provided only for assisting in the understanding for the background of the present invention and should not be considered as corresponding to the related art known to those skilled in the art.

### SUMMARY

The present invention provides a variable charge motion (VCM) apparatus for an engine and a diagnostic method capable of stably implementing appropriate functions of the VCM apparatus while suppressing increased costs related to manufacturing the engine, by diagnosing failure conditions such as a deformation of a flap or damage to a link that connects the flap to a VCM actuator without a need for an additional sensor installed adjacent to the flap.

According to an exemplary embodiment of the present invention, a VCM apparatus for an engine may include: a flap configured to be rotatably mounted within an intake manifold, to create tumble in a combustion chamber; a link configured to deliver an operating force to rotate the flap; a VCM actuator including a motor configured to generate an operating force delivered to the flap via the link; and a controller configured to operate the VCM actuator, in which an operating range of the motor exceeds the overall rotating range through which the flap normally rotates within the intake manifold and also exceeds both limits of the overall rotating range of the flap. In addition, the VCM actuator may be configured to include a motor position sensor configured to sense an operating position of the motor in the operation range of the motor exceeding both limits of the overall rotating range of the flap, to provide the sensed position to the controller.

According to another exemplary embodiment of the present invention, there is provided a diagnostic method for a VCM apparatus for an engine. The VCM apparatus may be configured to include a flap mounted within an intake manifold to rotate within a predetermined rotating range to generate tumble, a motor may be disposed within a VCM actuator, configured to drive the flap, and a motor position sensor configured to sense an operating position of the motor and transmit the operating position of the motor to a controller. The diagnostic method may include: receiving, by the controller, the operating position of the motor sensed by the motor position sensor; comparing, by the controller, whether the input operating position of the motor deviates from a normal rotating range of the flap; and in response to determining that the operating position of the motor deviates from the normal rotating range of the flap, determining, by the controller, that the VCM apparatus has failed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary diagram illustrating a VCM apparatus according to an exemplary embodiment of the present invention;

FIG. 2 is an exemplary diagram viewed from direction II of FIG. 1 and is a detailed view of an engine block coupling side of an intake manifold (according to an exemplary embodiment of the present invention);

FIG. 3 is an exemplary diagram separately illustrating a flap of FIG. 2;

FIG. 4 is an exemplary conceptual diagram illustrating the overall configuration of the VCM apparatus according to an exemplary embodiment of the present invention;

FIG. 5 is an exemplary conceptual diagram of a rotating angle of the flap and an operating range of a motor according to an exemplary embodiment of the present invention;

FIG. 6 is an exemplary block diagram illustrating a controller according to an exemplary embodiment of the present invention; and

FIG. 7 is an exemplary flow chart illustrating a diagnostic method of the VCM apparatus of the engine according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although the exemplary embodiments are described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

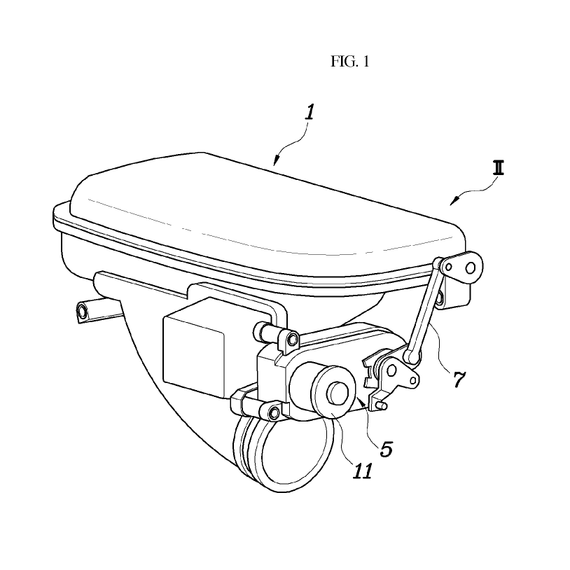

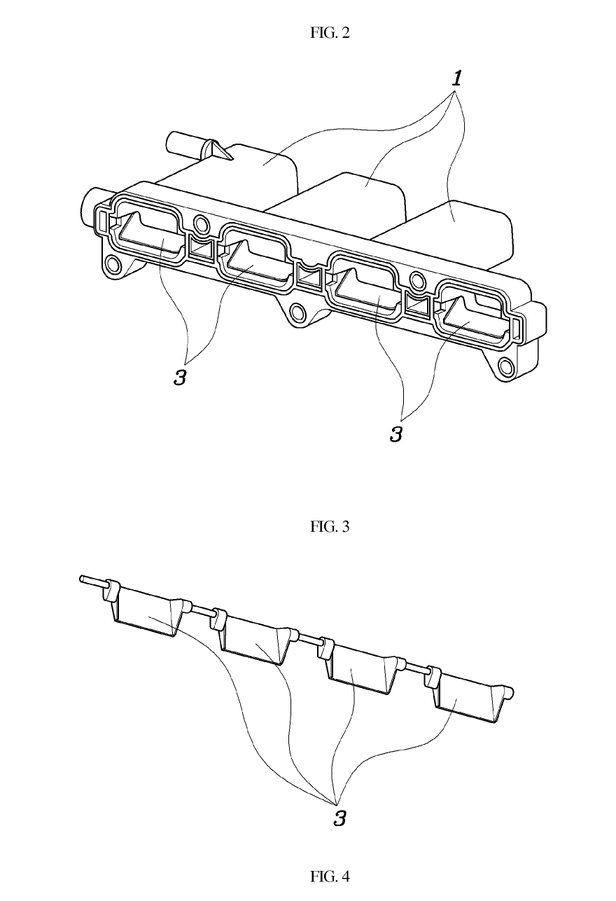

Referring to FIGS. 1 to 6, a VCM apparatus for an engine according to an exemplary embodiment of the present invention may include: a flap 3 configured to be rotatably mounted within an intake manifold 1 to create tumble in a combustion chamber; a link 7 configured to deliver an operating force to rotate the flap 3; a VCM actuator 5 including a motor 11 configured to generate an operating force to be delivered to the flap 3 via the link 7; and a controller 9 configured to operate the VCM actuator 5.

According to exemplary embodiments of the present invention, an operating range of the motor may exceed the overall rotating range through which the flap 3 normally rotates within the intake manifold 1. The operating range of the motor may also exceed both limits of the overall rotating range of the flap 3. Such limits may include a first limit in a first rotational direction, (e.g., clockwise), and a second limit in a second rotational direction, opposite the first rotational direction, (e.g., counterclockwise). The VCM actuator 5 may include a motor position sensor 13 configured to sense an operating position of the motor in the operation range of the motor, wherein the operating range of the motor exceeds both limits of the overall rotating range of the flap 3 to provide the sensed operating position of the motor to the controller 9. In other words, according to an exemplary embodiment of the present invention, the operating range of the motor may be set to include the overall normal rotating range of the flap 3 and to include a rotational range that exceeds an upper limit and a lower limit of the rotating range of the flap and the operating position of the motor, within an entire range, may be sensed by the motor position sensor 13.

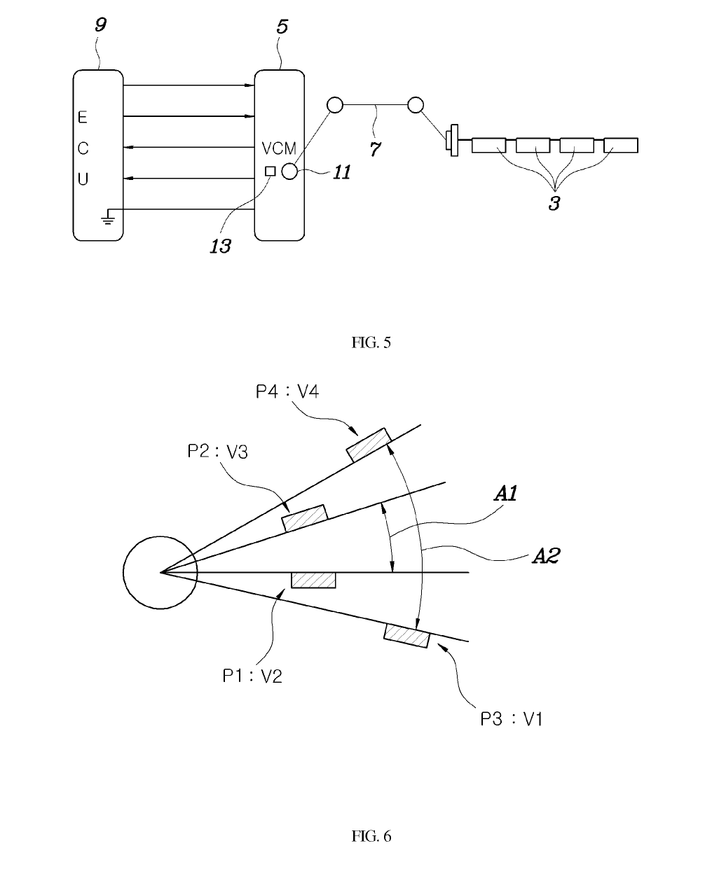

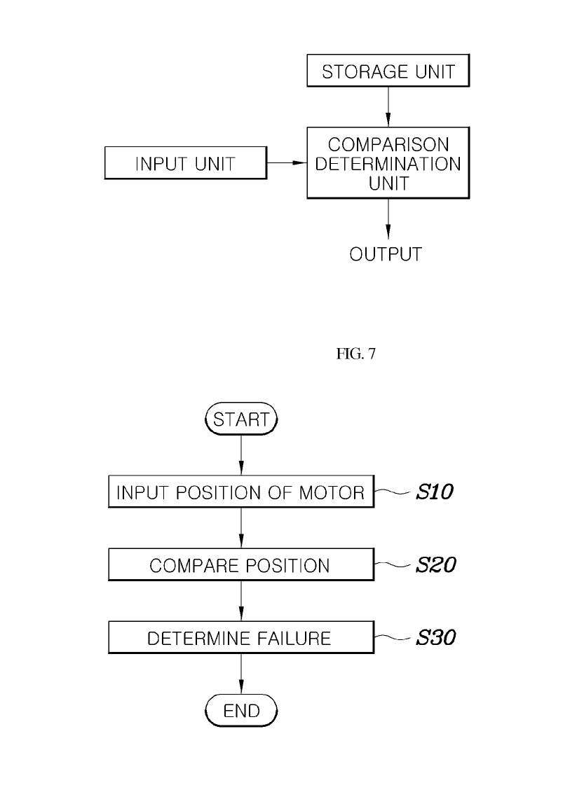

When the operating position of the motor provided by the motor position sensor 13 corresponds to a position deviating from an overall normal rotating range of the flap 3, the controller 9 may be configured to determine a failure of the VCM apparatus. For example, as illustrated in FIG. 6, the controller 9 may be configured to receive a signal for the operating position of the motor from the motor position sensor 13. The controller may include memory configured to store data regarding a normal operating range of the motor which includes the operating range of the motor exceeding an overall normal rotating range of the flap 3 and a comparison determiner configured to compare whether the operating position of the motor deviates from the normal operating range of the motor stored in the memory to determine whether the VCM apparatus has failed. The motor position sensor 13 may include any of a plurality of various sensors such as a potentiometer configured to measure a change in a magnitude of an output voltage generated in response to change in the operating position of the motor.

FIG. 5 illustrates further details in an exemplary embodiment of the present invention. The overall rotating range through which the flap 3 normally rotates may be limited by a first stopper P1 and a second stopper P2. In addition, the overall operating range of the motor may be limited by a third stopper P3 and a fourth stopper P4. It should be understood that the normal rotation range of the flap includes the rotation range in a state where neither the flap 3, nor the link 7 nor other parts are damaged. As illustrated, the first stopper P1 and the second stopper P2 may be implemented by a wall surface of the intake manifold 1, a separate protrusion that protrudes from the intake manifold 1, the flap 3, or the like. Consequently, the first stopper P1 and the second stopper P2 may be implemented by a mechanical configuration limiting rotation of the flap 3 to an appropriate range within the intake manifold 1 to create tumble in the combustion chamber.

The third stopper P3 and the fourth stopper P4 may be mechanical configurations mounted within the VCM actuator 5 to limit a range through which the motor may be operated. The positions of the first stopper P1 and the second stopper P2 are between the positions of the third stopper P3 and the fourth stopper P4 in the operating (rotational) range of the motor. The operating positions of the motor may include the interval between the first stopper P1 and the second stopper P2 (e.g., corresponding to the normal operating range of the flap 3) as well as the interval between the first stopper P1 and the third stopper P3 and an interval between the second stopper P2 and the fourth stopper P4.

As an example of motor position sense operation, the motor position sensor 13 may be configured to output a voltage of V1 when the operating position of the motor is positioned at the third stopper P3, a voltage of V2 when the operating position of the motor is positioned at the first stopper P1, a voltage of V3 when the operating position of the motor is positioned at the second stopper P2, and a voltage of V4 when the operating position of the motor is positioned at the fourth stopper P4 and the output values of the motor position sensor 13 may have a relationship of V1<V2<V3<V4. Furthermore, the controller 9 may be configured to determine a failure of the VCM apparatus when the output value of the motor position sensor 13 is between V1 and V2 or between V3 and V4. When the output value of the motor position sensor 13 is between V2 and V3, the controller may be configured to determine that the VCM apparatus is in a normal state or operation, (e.g., no failure).

Moreover, exemplary embodiments of the present invention allow for output values of the motor position sensor compared with V1, V2, V3, and V4, to be within predetermined ranges adjacent to V1, V2, V3, and V4, respectively. When V1, V2, V3, and V4, are determined to be within those ranges, the VCM apparatus may not be determined to have failed, (may be determined to be in a normal state). Such exemplary embodiments allow for mechanical error when sensing motor position. For reference, FIG. 5 illustrates an overall normal rotating range of the flap, represented by an angle A1 limited by the first stopper P1 and the second stopper P2 and the overall operating range of the motor represented by an angle A2 limited by the third stopper P3 and the fourth stopper P4, in which A1<A2.

Referring to FIG. 6, according to an exemplary embodiment of the present invention, a diagnostic method for the VCM apparatus including a flap 3 mounted within the intake manifold 1 and rotatable within a predetermined rotating range to generate tumble, a motor 11 disposed within the VCM actuator 5 configured to drive the flap 3, and a motor position sensor 13 configured to sense an operating position of the motor, may include: receiving, by a controller, an operating position of the motor sensed by the motor position sensor 13 (S10); comparing, by the controller, whether the operating position of the motor deviates from a normal rotating range of the flap 3 (S20); and determining, by the controller, in response to determining that the operating position of the motor deviates from the normal rotating range of the flap 3, that the VCM apparatus has failed (S30).

The range through which the motor position sensor 13 may be configured to sense the operating position of the motor may include the overall normal rotating range of the flap 3 and ranges in excess of both limits of the rotating range of the flap 3. In other words, the operating position of the motor may be sensed within the normal range of rotation of the flap, illustrated as angle A1 in FIG. 5, as well as the rotating ranges beyond angle A1, illustrated as the portions of angle A2 beyond angle A1, as described above. Meanwhile, in the comparison of the motor position (S20), the controller may be configured to determine whether the operating position of the motor deviates from either of the limits of the rotating range of the flap 3, (e.g., the clockwise limit and the counter clockwise limit) In the determination of the failure (S30), a failure of the VCM apparatus may be made in response to a determining that the operating position of the motor deviates from either of the limits of the rotating range of the flap 3. In other words, when the flap 3 of the VCM apparatus is deformed or the link 7 that connects the VCM actuator 5 to the flap 3 is deformed or damaged, the motor of the VCM actuator 5 may rotate to a point deviating from the normal rotating range of the flap 3 and when such a condition is detected, the controller 9 may be configured to determine that the VCM apparatus has failed. Accordingly, a VCM apparatus failure may be diagnosed without a separately mounted sensor for confirming whether the flap 3 is operating within a normal range of rotation.

As described above, according to exemplary embodiments of the present invention, it may be possible to more stably implement appropriate functions of the VCM apparatus while suppressing an increase costs of engine manufacture by diagnosing failure conditions such as those associated with the deformation of a VCM flap or damage to a link connecting the flap to a VCM actuator, without the addition of a sensor near the flap.

Although the present invention has been shown and described with respect to specific exemplary embodiments, it will be obvious to those skilled in the art that the present invention may be variously modified and altered without departing from the spirit and scope of the present invention as defined by the following claims.

What is claimed is:

1. A variable charge motion (VCM) apparatus of an engine, comprising:
a flap configured to be rotatably mounted within an intake manifold to create tumble in a combustion chamber;
a link configured to deliver an operating force to rotate the flap;
a VCM actuator including a motor configured to generate the operating force delivered to the flap via the link; and
a controller configured to operate the VCM actuator,
wherein an operating range of the motor exceeds the overall normal rotating range of the flap within the intake manifold and both limits of the overall rotating range of the flap, and
wherein the VCM actuator is configured to include a motor position sensor configured to:
sense an operating position of the motor in the operation range of the motor exceeding both limits of the overall rotating range of the flap; and
transmit the sensed operating position of the motor to the controller.

2. The VCM apparatus of claim 1, wherein the controller is further configured to determine that the VCM apparatus has failed in response to the operating position of the motor transmitted from the motor position sensor deviating from the overall normal rotating range of the flap.

3. The VCM apparatus of claim 1, wherein the controller is further configured to:
receive a signal for the operating position of the motor from the motor position sensor;
store data regarding a normal operating range of the motor, which includes the operating range of the motor exceeding an overall normal rotating range of the flap; and
compare whether the operating position of the motor deviates from the stored normal operating range of the motor stored in the memory to determine whether the VCM apparatus has failed.

4. The VCM apparatus of claim 1, wherein the overall rotating range of the flap is limited by a first stopper and a second stopper,
the overall operating range of the motor is limited by a third stopper and a fourth stopper,
the motor position sensor is configured to output a voltage of V1 when the operating position of the motor is at the third stopper, a voltage of V2 when the operating position of the motor is at the first stopper, a voltage of V3 when the operating position of the motor is at the second stopper, and a voltage of V4 when the operating position of the motor is at the fourth stopper,
the output values of the motor position sensor have a relationship of V1<V2<V3<V4, and
the controller is configured to determine the VCM apparatus has failed in response to the output value of the motor position sensor being between V1 and V2 or between V3 and V4.

5. A diagnostic method for a variable charge motion (VCM) apparatus for an engine, the VCM apparatus including a flap disposed within an intake manifold and rotatable within a predetermined rotating range to generate tumble, a motor disposed within a VCM actuator configured to drive the flap, and a motor position sensor configured to sense an operating position of the motor, the diagnostic method comprising:
receiving, by a controller, the operating position of the motor sensed by the motor position sensor;
determining, by the controller, whether the input operating position of the motor deviates from a normal rotating range of the flap; and
in response to determining that the operating position of the motor deviates from the normal rotating range of the flap, determining, by the controller, that the VCM apparatus has failed.

6. The diagnostic method of claim 5, wherein a range in which the motor position sensor senses the operating position of the motor includes the normal rotating range of the flap and exceeds both limits of the normal rotating range of the flap.

7. The diagnostic method of claim 6, further comprising:
determining, by the controller whether the operating position of the motor deviates from one of the limits of the rotating range of the flap; and
the determining, by the controller, that the operating position of the motor deviates from one of the limits of the rotating range of the flap.

8. A non-transitory computer readable medium containing program instructions executed by a controller configured perform a diagnostic method for a variable charge motion (VCM) apparatus for an engine, the VCM apparatus including a flap disposed within an intake manifold and rotatable within a predetermined rotating range to generate tumble, a motor disposed within a VCM actuator configured to drive the flap, and a motor position sensor configured to sense an operating position of the motor, the computer readable medium comprising:
program instructions that receive information regarding the operating position of the motor sensed by the motor position sensor;
program instructions that determine whether the input operating position of the motor deviates from a normal rotating range of the flap; and
program instructions that, in response to determining that the operating position of the motor deviates from the normal rotating range of the flap, determine that the VCM apparatus has failed.

9. The non-transitory computer readable medium of claim 8, wherein a range in which the motor position sensor senses the operating position of the motor includes the normal rotating range of the flap and exceeds both limits of the normal rotating range of the flap, the computer readable medium further comprising:
program instructions that determine whether the operating position of the motor deviates from one of the limits of the rotating range of the flap,
the program instructions that, in response to determining that the operating position of the motor deviates from one of the limits of the rotating range of the flap, determine that the VCM apparatus has failed.
